(19) United States
(12) Patent Application Publication
(10) Pub. No.: US 2014/0100277 A1
(43) Pub. Date: Apr. 10, 2014

(54) SOLUTIONS AND METHODS OF MAKING SOLUTIONS TO KILL OR DEACTIVATE SPORES, MICROORGANISMS, BACTERIA AND FUNGUS

(71) Applicants: Robert Gray, Hudson, OH (US); Keith A. Pelfrey, Wadsworth, OH (US); Chris Fricker, Copley, OH (US); James Bingham, Akron, OH (US)

(72) Inventors: Robert Gray, Hudson, OH (US); Keith A. Pelfrey, Wadsworth, OH (US); Chris Fricker, Copley, OH (US); James Bingham, Akron, OH (US)

(73) Assignee: EP Technologies LLC, Akron, OH (US)

(21) Appl. No.: 13/842,574

(22) Filed: Mar. 15, 2013

Related U.S. Application Data
(60) Provisional application No. 61/710,263, filed on Oct. 5, 2012.

(51) Int. Cl. A01N 37/36

(52) U.S. Cl. CPC A01N 37/36
USPC 514/557

(57) ABSTRACT

Exemplary embodiments of solutions of plasma activated water and peroxyacetic acid are disclosed herein. In addition, exemplary embodiments of methods for making solutions are disclosed herein. Some methods include exposing water to a plasma gas to activate the water, adding acetic acid to the activated water; and mixing the acetic acid and activated water to form a solution. Additional exemplary methods include adding acetic acid to water to form a solution, mixing solution of acetic acid and water together; and exposing the solution to a plasma gas to activate the solution. Another exemplary embodiment includes exposing water to a plasma gas to activate the water; adding an acetyl group donor to the activated water; and mixing the acetyl group donor and activated water to form a solution.

### RELATED APPLICATIONS

This non-provisional utility patent application claims priority to and the benefits of U.S. Provisional Patent Application Ser. No. 61/710,263 filed on Oct. 5, 2012 and entitled SOLUTIONS AND METHODS OF MAKING SOLUTIONS TO KILL OR DEACTIVATE SPORES, MICROORGANISMS, BACTERIA AND FUNGUS, which is incorporated herein by reference in its entirety.

### TECHNICAL FIELD

The present invention relates generally to solutions that may be used to kill or deactivate spores, microorganisms, bacteria and fungus. More particularly, the present invention relates to a solution comprising plasma activated water and peroxyacetic acid.

### BACKGROUND OF THE INVENTION

Peroxyacetic acid, also known as peracetic acid or PAA is an organic compound with the formula CH₃CO₃H or C₂H₄O₃. Peroxyacetic acid is formed by the reaction product of acetic acid (CH₃COOH) and hydrogen peroxide (H₂O₂) in liquid solution in the presents of a catalyst, such as sulfuric acid. The chemical reaction is shown below.

CH₃COOH +H₂O₂ [symbol] CH₃CO₃H

Peroxyacetic acid is a strong oxidizing agent and also has a broad spectrum of antimicrobial activity. Peroxyacetic acid mixtures may be used as sanitizers in the food industry since they can control deposits, odors and biofilms on the surfaces in contact with food, such as fresh fruits and vegetables. An advantage to the use of peroxyacetic acid is that the products formed during the degradation process, acetic acid, hydrogen peroxide, water and oxygen, are not harmful.

Generally, peroxyacetic acid is produced by a batch process by feeding acetic acid and hydrogen peroxide into an aqueous reaction medium containing a sulfuric acid catalyst. The reaction is allowed to continue for up to ten days in order to achieve high yields of product. In addition, peroxyacetic acid is generally shipped in a concentrated form to the end user and is diluted prior to use. Shipping of concentrated peroxyacetic acid as a class 5.2 oxidizer and is very corrosive to soft metals and skin and can cause damage to the lungs. Shipping diluted peroxyacetic acid is cost prohibitive and dilute peroxyacetic acid is not very stable and tends to degrade.

### SUMMARY

Exemplary embodiments of solutions of plasma activated water and peroxyacetic acid are disclosed herein.

In addition, exemplary embodiments of methods for making solutions are disclosed herein. Some methods include exposing water to a plasma gas to activate the water, adding acetic acid to the activated water; and mixing the acetic acid and activated water to form a solution. Additional exemplary methods include adding acetic acid to water to form a solution, mixing solution of acetic acid and water together; and exposing the solution to a plasma gas to activate the solution. Another exemplary embodiment includes exposing water to a plasma gas to activate the water; adding an acetyl group donor to the activated water; and mixing the acetyl group donor and activated water to form a solution.

In addition, exemplary methods of making a peroxyacetic acid solution are disclose herein and include exposing water to a plasma gas to activate the water; adding acetic acid to the activated water; and mixing the acetic acid and activated water together.

Exemplary embodiments of methods of deactivating or killing a spore, virus, microorganism, bacteria or fungi are also disclosed herein. Some embodiments include applying a solution of plasma activated water and peroxyacetic acid to a spore, microorganism, virus, bacteria or fungi.

In addition, exemplary embodiments for apparatuses for creating a solution for killing or deactivating a spore, virus, microorganism, bacteria or fungi are also disclosed herein. include a plasma generator for generating plasma located in the housing; an inlet for receiving water; an activation chamber for activating the water with plasma generated from the plasma generator; an inlet for receiving acetic acid; a mixing chamber for mixing the water and the acetic acid together to create a solution; and an outlet for outputting the solution.

### BRIEF DESCRIPTION OF THE DRAWINGS

These and other features and advantages of the present invention will become better understood with regard to the following description and accompanying drawings in which:

FIG. 1 illustrates an exemplary embodiment of a system for creating a solution to kill or deactivate spores, microorganisms, bacteria and fungus; and

FIGS. 2 through 4 illustrate exemplary methods for creating a solution to kill or deactivate spores, microorganisms, bacteria and fungus.

### DETAILED DESCRIPTION

Embodiments of the present invention create peroxyacetic acid by treating water and acetic acid with plasma. Treating the solution with plasma creates a solution that contains peroxyacetic acid and other radicals. In some cases the water is treated with plasma to activate the water and acetic acid is added to the activated water to create a solution containing peroxyacetic acid. In others, acetic acid is added to the water and the solution is treated with plasma to activate the water and to create peroxyacitic acid in the solution. The resulting solution containing activated water and peroxyacetic acid has been found effective in inactivating or killing spores, microorganisms, bacteria, virus and fungus more efficiently then current methods.

Plasmas, or ionized gases, have one or more free electrons that are not bound to an atom or molecule. Non-thermal plasmas provide high concentrations of energetic and chemically active species. They can operate far from thermodynamic equilibrium with high concentrations of active species and yet remain at a temperature that is substantially the same as room temperature.

The energy from the free electrons may be transferred to additional plasma components creating additional ionization, excitation and/or disassociation. Fluid that is contacted with plasma becomes “activated” and is referred to herein as plasma activated fluid, and in some embodiments, the plasma activated fluid is plasma activated water.

In some embodiments, plasmas may contain superoxide anions [O2.—], which react with H+ in acidic media to form hydroperoxy radicals, HOO.: [O2.—]+[H+]→[HOO.]. Other radical species may include OH. and NO. in aqueous phase or the presence of air or gas. Treating water with plasma results in plasma activated water that contains concentrations of one or more of H₂O₂, nitrates and nitrites.

Because plasma activated water contains H₂O₂, the addition of acetic acid (CH₃COOH) results in a solution that includes peroxyacetic acid: CH₃COOH+H₂O₂ [symbol] CH₃CO₃H. In some embodiments the acetic acid is added after the water is activated with the plasma. In some embodiments, the acetic acid is added before the solution is activated with the plasma. In some embodiments, the formation of peroxyacetic acid by mixing plasma activated water and acetic acid does not require the use of a catalyst.

Activating water with plasma to obtain plasma activated water is shown and described in co-pending U.S. Provisional Application Ser. No. 61/621078 titled Sanitization Station Using Plasma Activated Fluid, filed on Apr. 6, 2012 as well as several other patents and applications such as: PCT Application Nos. WO 02/059046, titled Method of Activation of Chemically Pure and Potable Water and filed on Jan. 25, 2002; WO 2007/048806, titled Method for the Preparation of Biocidal Activated Water Solutions and filed Oct. 25, 2006; WO 2012/018891, which is titled Materials for Disinfection Produced by Non-Thermal Plasma and was filed on Aug. 3, 2011; and U.S. Pat. No. 7,291,314, titled Activated Water Apparatus and Methods and filed Dec. 20, 200. Each of these patents and patent applications are incorporated herein by reference in their entirety for their disclosures on generating plasma and activating water.

In addition, the properties of the fluid, for example water, may be altered prior to activation by plasma to increase or decrease concentration of radicals. For example, the pH of water may be adjusted to be acidic or basic. In one embodiment, the pH of the water is between about 2 and 3.5, in another is between about 2 and 3.5, and in yet another is about 2.7. The pH may be adjusted by, for example, adding acid to the water prior to activation. The pH level may be lowered through the activation process. In one embodiment, adjusting the pH levels adjusts the concentrations of radicals allowing for the adjustment of the efficacy of the plasma activated water to inactivate or kill spores, microorganisms, bacteria, etc.

In one embodiment, the pH level of the activated water is between about 2.0 and 3.5, in another the pH is between about 2.0 and 3.5, and in yet another is about 2.7. Still in another the pH is less than about 3 and in another embodiment is less than about 2.0. In one embodiment, the pH is about 2.0.

In addition, the properties of the activated water may be adjusted during the activation process itself by altering the gas that is ionized. For example, the gas that is ionized may be normal air, nitrogen, N₂, Oxygen, O₂, He or combinations thereof

Further, additives such as, for example, alcohol may be added before or after the fluid is activated to increase efficacy or stabilization of the resulting solution.

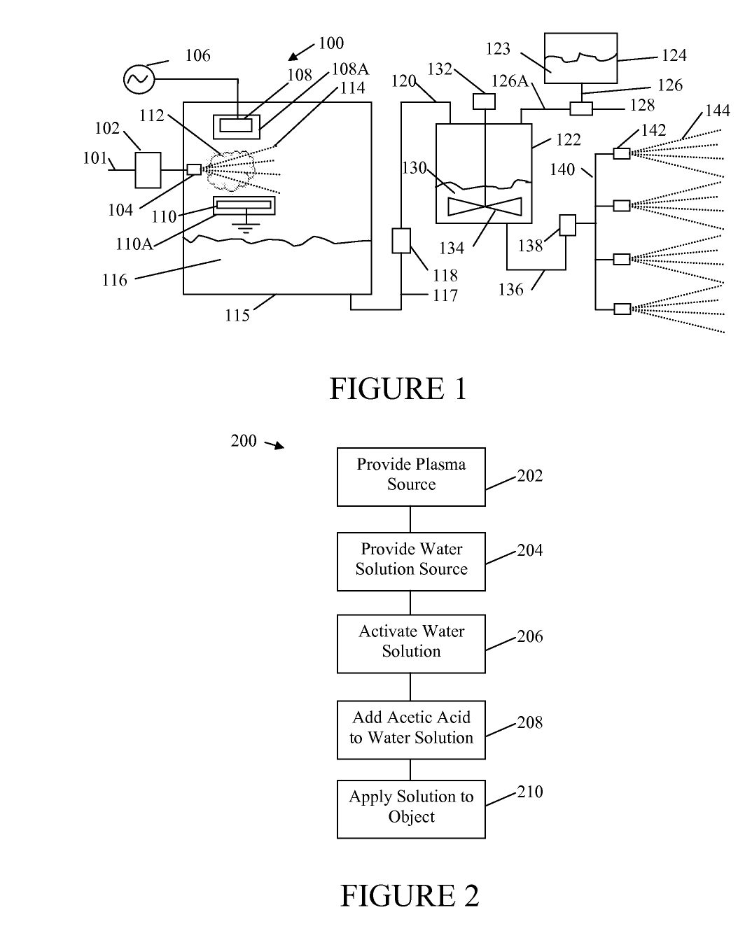

FIG. 1 illustrates and exemplary embodiment for a system 100 for creating a solution for inactivating or killing spores, bacteria microorganisms etc. The resulting solution includes peroxyacetic acid. The exemplary system 100 receives fluid from a fluid source 101. Fluid source 101 may be a source of water, or of water with additional additives. In one embodiment, the fluid is tap water, however, the water may be distilled water, tap water, filtered water, water with acidic properties, water with basic properties or water mixed with additives such as, for example, alcohol. In addition, other additives may be used to optimize generation or increase performance and/or increase stability. These additives may include, for example chelators to reduce metal degradation; surfactants to improve penetration of the solution to reduce the impact of organic load and/or buffers to adjust the pH. In addition, in some embodiments corrosion inhibitors may be added, such as, for example, inorganic sulfates, inorganic phosphates. In some embodiments, a zeolite buffering system may be used. In some embodiments, one or more of these additives are added prior to activation of the water. In some embodiments, one or more of these additives are added after activation of the water.

A pump 102 pumps the fluid through a nozzle 104. Nozzle 104 provides a fluid output 114 through a plasma gas 112. Fluid output 114 may be a fluid stream output, a fluid mist output, an atomized fluid output or the like.

System 100 includes a pair of electrodes 108, 110 having dielectric barriers 108A, 110A. Electrode 108 is connected to a high voltage source 106. In this embodiment, when the electrodes are activated, a plasma gas 112 is formed between the two electrodes. The plasma gas 112 may be generated from ambient air or from a gas, such as, for example, nitrogen or gas mixture. Fluid 114 is passed through the plasma gas 112 in the form of a stream, mist or atomized vapor and is activated. Optionally, the plasma gas 112 may contact the fluid by other means, such as for example, surface contact, formation of plasma within the liquid as microbubbles. In the exemplary embodiment, the fluid 114 is activated and collects as an activated fluid 116 in the bottom of container 115, also referred to as the activation chamber. The activated fluid 116 is pumped through lines 117 and 120 by pump 118 into a second container 122, also referred to as the mixing chamber. In one embodiment, pump 118 is a metering pump which allows a relatively precise amount of activated fluid to be pumped into container 122. Acetic acid is pumped from container 124 through lines 126, 126A by pump 128. The acetic acid 123 in container 124 may have any concentration, and in one embodiment is about 35% acetic acid. In one embodiment, pump 128 is a metering pump, which allows a relatively precise amount of acetic acid to be pumped into container 122.

The solution 130 of activated fluid 117 and acetic acid 123 is mixed in container 122 by an agitator 134 which is moved by motor 132. The H₂O₂ in the activated water reacts with the acetic acid to form peroxyacetic acid within the solution 130. In one embodiment, the solution 130 contains between about 25 to 200 parts per million of peroxyacetic acid. In another embodiment, the solution 130 contains between about 80 to 180 parts per million. In yet another embodiment, the solution 130 contains about 80 to 120 parts per million of peroxyacetic acid. Some embodiments the solution 130 contains between about 0.0025% and 0.02% peroxyacetic acid. Some embodiments contain less than about 0.02% peroxyacetic acid and some contain about 0.01% peroxyacetic acid. In some embodiments, the solution 130 has a concentration of less than 1.0% peroxyacetic acid solution.

In addition, in some embodiments, it is believed that additional nitric species in the solution 130 generated by the plasma water activation aids in accelerating the kill or inactivation of the bacteria, fungus and spores.

The solution 130 is pumped out of container 122 through line 136, header 140 and spray nozzles 142 by pump 138. Nozzles 142 may be, for example, spray nozzles, piezoelectric elements, atomizing nozzles, misting nozzles, a jet nozzle, etc. Nozzles 142 may provide a spray, mist, fog, atomized mist, vapor or the like. In some embodiments, the solution 130 is sprayed onto an object to kill or inactivate spores, microorganisms, bacteria, fungus or the like.

Exemplary system 100 allows a disinfectant/sporicidal solution 130 to be created on site from safe material, such as water and acetic acid and thus, eliminates the dangers associated with shipping and handling concentrated peroxyacetic acid. In addition, the solution 130 breaks down during the degradation process into acetic acid, hydrogen peroxide, water and oxygen which are not harmful. In some embodiments, the solution 130 is applied to an object within 24 hours of making the solution 130. In some embodiments, the solution 130 is applied to an object within 1 hour of making the solution. In some embodiments, the solution 130 is applied to an object within 5 minutes of making the solution 130.

In one embodiment, container 115 is filled with air or has an air inlet source. Optionally, however, container 115 may be filled with other gasses such as, for example, N2, O2 or He; or a combination of one or more of these gases may be used. The gasses may be supplied under atmospheric pressure or under a pressure that is higher or lower than atmospheric pressure. A gas inlet passage (not shown) into container 115 may be provided. Optionally, the gas may not fill container 115, but may be directed to the location of the plasma generation. The use of different gasses may allow tuning of the activated water so that the activated water may have more efficacy killing all bacteria, spore, microorganism of fungus, or may be tuned to have a different efficacy at killing different types of bacteria, spore, microorganisms or fungus.

The solution 130 may be used to treat objects, such as, for example, rooms, a hospital beds, instruments, hands, skin, wounds, produce, meat products, and the like.

The exemplary embodiment of system 100 illustrates the activation chamber in container 115 as being upstream of the mixing chamber in container 122. In some exemplary embodiments, the activation chamber is located downstream of the mixing chamber.

Although acetic acid is used and described in the exemplary embodiments, other acetyl group donors may be used, such as for example, acetylsalicylic acid and peroxide generators such as perborates may be further activated by plasma. In addition, although the exemplary embodiments describe use of a liquid as the acetyl group donor, acetyl group donors in other forms may be used, such as those in a solid form.

FIG. 2 illustrates an exemplary methodology 200 for creating a solution for killing spores, fungus and bacteria. The exemplary methodology begins by providing a plasma source at block 202. A source of water is provided at block 204 and the water is activated at block 206 by contacting the water with plasma gas created by the plasma source. Acetic acid is added to the activated water solution at block 208 and the solution is mixed together. The solution is then applied to an object at block 210.

It has been found that the mixture of activated water and acetic acid kills or inactivates spores. It has also been found that the mixture of activated water and acetic acid kills or inactivates clostridium difficile (“C diff”) in less time than it takes to kill C diff with bleach which takes at least about 5 minutes. In one embodiment, C diff spores were inactivated in about 30 seconds.

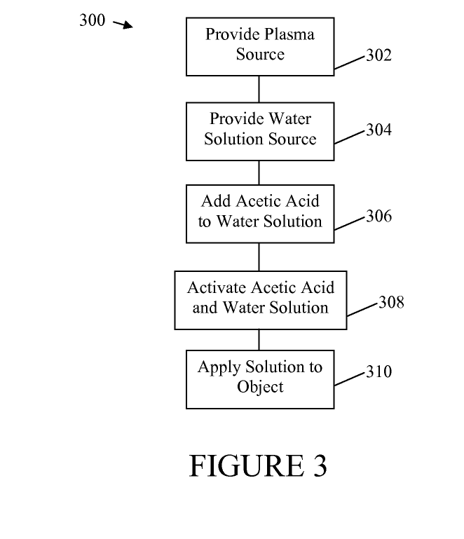

FIG. 3 illustrates another exemplary methodology 300 for creating a solution for killing spores, fungus and bacteria. The exemplary methodology begins by providing a plasma source at block 302. A source of water is provided at block 304. Acetic Acid is added to the water from the water source at block 306 and the solution is mixed together. The solution is activated at block 308 by contacting the solution with plasma gas generated by the plasma source. The solution is then applied to an object at block 310.

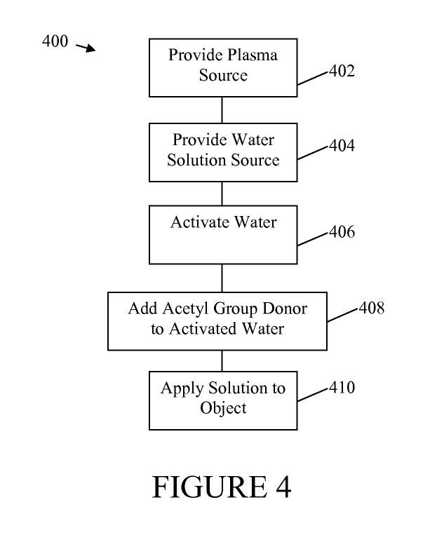

FIG. 4 illustrates another exemplary methodology 400 for creating a solution for killing spores, fungus and bacteria. The exemplary methodology begins by providing a plasma source at block 402. A source of water is provided at block 404. The water is activated at block 406 by contacting the solution with plasma gas generated by the plasma source. An acetyl group donor is added to the activated water at block 408, which forms a solution containing peroxyacetic acid. The solution is then applied to an object at block 410.

Experimental results demonstrate that C diff spores may be inactivated or killed within about 30 seconds. In one experiment, a solution of 1.5 ml of purified water was exposed to a dielectric barrier discharge plasma generator operating at a frequency of 3500 Hz, a pulse width of 10 us and a 100% duty cycle. The electrode gap was 1.5 mm +/−0.5 mm for 90 seconds. The pH of the water lowered from 6 to 2. 0.2 ml of 35% diluted acetic acid solution was added to the activated water within 20 seconds of activation. The resulting solution contained between about 85-160 parts per million peroxyacetic acid. The solution was used on the test medium (spores, bacteria, etc.) within 5 minutes. It was found that the solution inactivated C diff spores within about 30 seconds.

Additional experiments included the same plasma source and also used 1.5 ml of water. 0.1 ml of diluted acetic acid was added to the water prior to activation of the water and the resulting solution demonstrated a 2.34 log kill of C diff in 30 seconds and a 2.81 log kill in 5 minutes. 0.1 ml of diluted acetic acid was added to the water after activation of the water and the resulting solution demonstrated a 1.08 log kill of C diff in 30 seconds and a 1.33 log kill in 5 minutes. 0.2 ml of diluted acetic acid was added to the water prior to activation of the water and the resulting solution demonstrated a 2.41 log kill of C diff in 30 seconds and a 2.81 log kill in 5 minutes. 0.2 ml of diluted acetic acid was added to the water after activation of the water and the resulting solution demonstrated a greater than 2.81 log kill of C diff in 30 seconds and a greater than 2.81 log kill in 5 minutes.

The solution formed by adding an acetyl group donor to activated water, such as adding acetic acid to activated water, to obtain a solution that includes peroxyacetic acid has a kill or deactivation rate that is superior to that of activated water or peroxyacetic acid alone. In addition, in some embodiments an advantage of creating a peroxyacetic acid solution by using non-thermal plasma is that you do not need to heat these solutions. Heating the solutions often increases the kinetics or the rate of degradation of the chemical compounds.

Treating Escherichia coli (“E. coli”) bacteria with a fluid that contained plasma activated water and acetic acid resulted in a fluid having superior kill power over either plasma activated water alone or a solution of water and acetic acid alone.

The below experiments were conducted on E. coli in solution. The plasma setup was a dielectic barrier discharge plasma system. An alternating voltage pulsed power supply was used in the experiment to generate pulsed voltage for creating plasma. The pulse frequency was 3.5 kHz and the pulse duration was 10 μs. The amplitude of the voltage pulse was 20 kV peak to peak with a 5 V/ns rise time. The gap distance between the plasma generating system and the treated surface was about 1 to 2 mm. The experiments used air as the plasma working gas under the pressure of 1 atmosphere (ambient pressure).

For the E coli inactivation tests, the standard testing method, ASTM 2315, was utilized. 10⁸ CFU/ml E. coli suspension was prepared in Physiological Saline (8.5 g/L NaCl). 10 μl of the E. coli bacteria solution was drawn and added to 990 μl of the plasma activated water. After being vortexed for 30 seconds, 0.1 ml of the mixture of the E. coli solution and the plasma activated water was added to 9.9 ml of neutralizer. The neutralizer solution containing E. coli bacteria was then diluted and plated on Tryptic Soy Agar. 24-hr incubation was performed at 37° C., followed by the estimation of colony forming units (CFU).

2.0 ml of tap water was activated by the plasma. 990 μl of the plasma activated water was mixed with 10 μl of the E. coli bacteria solution. And then the testing procedure described above was used to obtain the CFU of E. coli after the treatment using the plasma activated water. The test results demonstrated that treating E. coli for 30 seconds with plasma activated water (water exposed to plasma for 3 minutes) alone resulted in log reductions colony forming units per milliliter “CFU/ml” of bacteria of 0.77. Treating E. coli for 30 seconds with plasma activated water (water exposed to plasma for 5 minutes) alone resulted in a 0.84 log reduction (CFU/ml) of bacteria. In addition, E. coli bacteria was treated with a fluid made of 2.0 ml of tap water and 0.2 ml of 35% acetic acid. Treating the E. coli for 30 seconds with tap water and acetic acid resulted in only a 0.31 log reduction (CFU/ml) of E. coli bacteria.

| | Direct Plasma | | Log |
|---|---|---|---|
| | Activation | Treatment | Reduction |
| Solution | Time | Time | (CFU/ml) |
| 2.0 ml water | 3 min | 30 sec | 0.77 |
| 2.0 ml water | 5 min | 30 sec | 0.84 |
| 2.0 ml of tap water and 0.2 ml | — | 30 sec | 0.31 |
| of 35% acetic acid | | | |

E. coli bacteria treated with a fluid made up of 2.0 ml of plasma activated water and 0.267 ml of 35% acetic acid resulted in a fluid having a superior kill rate than either plasma activated water or acetic acid alone. Treating E. coli with the fluid made up of plasma activated water (water exposed to plasma for 3 minutes) and acetic acid for 30 seconds resulted in a 4.44* log reduction (CFU/ml) of bacteria. In addition, treating E. coli for 30 seconds with the fluid made up of plasma activated water (water exposed to plasma for 5 minutes) and acetic acid resulted in a greater than 4.44* log reduction (CFU/ml) of bacteria. (*A 4.44 log reduction was the upper limit of the test equipment used, and, accordingly, the actual log reduction of E. coli bacteria was likely well above a 4.44 log reduction.) Thus, the experimental results demonstrate that the efficacy of plasma activated water and acetic acid is superior to the efficacy of plasma activated water alone or acetic acid alone.

| | Direct Plasma | | |
|---|---|---|---|
| | Activation | Treatment | Log Reduction |
| Solution | Time | Time | (CFU/ml) |
| 2.0 ml of tap water and | 3 min | 30 sec | 4.44* |
| 0.267 ml of 35% acetic | | | |
| acid | | | |
| 2.0 ml of tap water and | 5 min | 30 sec | 4.44* |
| 0.267 ml of 35% acetic | | | |
| acid | | | |

In addition to direct plasma, activated fluid may be fluid activated by indirect plasma, also known as “afterglow.” Direct plasma is generated as described above. Indirect plasma is obtained by generating plasma in the presence of a grounded filter, such as, for example, a copper mesh. In one embodiment, the copper mesh is located proximate the dielectric barrier of the DBD plasma generator. The grounded copper mesh prevents the charged ions and electrons from passing through, but allows the neutral species to pass through and active the fluid. Thus, the activated fluid or activated water may be activated by plasma or by indirect plasma. All of the embodiments described with reference to FIGS. 1-4 may be direct plasma or indirect plasma.

E. coli bacteria was treated with 2.0 ml of indirect plasma activate water. The test results demonstrated that treating E. coli for 30 seconds with indirect plasma activated water (water exposed to indirect plasma for 3 minutes) alone resulted in log reductions colony forming units per milliliter “CFU/ml” of bacteria of between 1.01 and 1.43. Treating E. coli for 30 seconds with plasma activated water (water exposed to indirect plasma for 5 minutes) alone resulted in a 1.43 log reduction (CFU/ml) of bacteria.

| | Activation | Treatment | |
|---|---|---|---|
| Solution | Time | Time | Log Reduction (CFU/ml) |
| 2.0 ml of tap water | 3 min | 30 sec | 1.01, 1.43 |
| 2.0 ml of tap water | 5 min | 30 sec | 1.43 |

Treating E. coli with the fluid made up of indirect plasma activated water (water exposed to indirect plasma for 3 minutes) and acetic acid for 30 seconds resulted in a 4.29 log reduction (CFU/ml) of bacteria. In addition, treating E. coli for 30 seconds with the fluid made up of plasma activated water (water exposed to indirect plasma for 5 minutes) and acetic acid resulted in a greater than 4.44* log reduction (CFU/ml) of bacteria.

| | Activation | Treatment | Log |
|---|---|---|---|
| Solution | Time | Time | Reduction (CFU/ml) |
| 2.0 ml of tap water and | 3 min | 30 sec | 4.29 |
| 0.267 ml of 35% acetic acid | | | |
| 2.0 ml of tap water and | 5 min | 30 sec | 4.44* |
| 0.267 ml of 35% acetic acid | | | |

While the present invention has been illustrated by the description of embodiments thereof and while the embodiments have been described in considerable detail, it is not the intention of the applicants to restrict or in any way limit the scope of the appended claims to such detail. Additional advantages and modifications will readily appear to those skilled in the art. Moreover, elements described with one embodiment may be readily adapted for use with other embodiments. Therefore, the invention, in its broader aspects, is not limited to the specific details, the representative apparatus and/or illustrative examples shown and described. Accordingly, departures may be made from such details without departing from the spirit or scope of the applicants' general inventive concept.

We claim:

1. A solution comprising:
activated fluid and peroxyacetic acid.

2. The solution of claim 1 wherein the fluid is activated by plasma.

3. The solution of claim 1 wherein the fluid is activated by indirect plasma.

4. The solution of claim 1 wherein the fluid is water.

5. The solution of claim 1 wherein the solution further comprises hydrogen peroxide and acetic acid.

6. The solution of claim 1 wherein the solution comprises less than about 200 parts per million of peroxyacetic acid.

7. The solution of claim 1 wherein the solution comprises less than about 160 parts per million of peroxyacetic acid.

8. The solution of claim 1 wherein the solution comprises less than about 85 parts per million of peroxyacetic acid.

9. The solution of claim 1 further comprising a pH of less than about 3.5.

10. The solution of claim 1 further comprising a pH of less than about 3.0.

11. The solution of claim 1 further comprising a pH of less than about 2.5.

12. The solution of claim 1 further comprising a pH of about 2.

13. The solution of claim 1 further comprising a chelating agent.

14. The solution of claim 1 further comprising a surfactant.

15. The solution of claim 1 further comprising a buffer.

16. A method of making a solution comprising:
activating water;
adding acetic acid to the activated water; and
mixing the acetic acid and activated water to form a solution.

17. The method of claim 16 wherein the water is activated by plasma.

18. The method of claim 16 wherein the water is activated by indirect plasma.

19. The method of claim 16 wherein the acetic acid is a diluted acetic acid solution.

20. The method of claim 16 wherein the acetic acid comprises about 35% acetic acid solution.

21. The method of claim 16 wherein the acetic acid comprises less than a 35% acetic acid solution.

22. The method of claim 16 wherein the acetic acid comprises less than about 8% percent of the solution.

23. The method of claim 16 wherein the plasma gas is created from air.

24. The method of claim 16 wherein the plasma gas is created from nitrogen.

25. A method of deactivating or killing a spore, virus, microorganism, bacteria or fungi comprising:
applying a solution of activated water and peroxyacetic acid to a spore, microorganism, virus, bacteria or fungi.

26. The method of claim 25 wherein the spore is clostridium difficile.

27. The method of claim 25 wherein the solution is left in contact with spore, microorganism, bacteria or fungi for less than about 1 minute and the kill rate is greater than about a 2 log kill.

28. The method of claim 25 wherein the solution is left in contact with spore, microorganism, bacteria or fungi for less than about 30 seconds and the kill rate is greater than about a 2 log kill.

29. The method of claim 25 further comprising creating the solution of activated water and peroxyacetic acid by exposing water to one or more species generated by plasma to activate the water and adding acetic acid to the activated water.

30. The method of claim 25 further comprising creating the solution of plasma activated water and peroxyacetic acid by adding acetic acid to water to form a mixture and exposing the mixture to plasma gas to activate the mixture.

31. The method of claim 25 further comprising applying the solution of plasma activated water and peroxyacetic acid to an object within 24 hours of making the solution.

32. A method of making a solution comprising:
exposing a fluid to plasma or indirect plasma to activate the water;
adding an acetyl group donor to the activated water; and
mixing the acetyl group donor and activated water to form a solution.

33. The method of making a solution of claim 32 wherein the acetyl group donor is acetic acid.

34. The method of making a solution of claim 32 wherein the acetyl group donor is acetylsalicylic acid.

35. The method of making a solution of claim 32 wherein the acetyl group donor is in a liquid form.

36. The method of making a solution of claim 32 wherein the acetyl group donor is in a solid form.
